(19) United States
(12) Patent Application Publication
(10) Pub. No.: US 2006/0239660 A1
(43) Pub. Date: Oct. 26, 2006

(54) Single piece optical mechanical assembly for optical data storage engines

(76) Inventors: Tony D. Combe, Dunfermline (GB); David Sheperd, Edinburgh (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/540,788

(22) PCT Filed: Dec. 24, 2003
(86) PCT No.: PCT/GB03/05722

§ 371 Date: May 25, 2006

(30) Foreign Application Priority Data
Jan. 9, 2003 (GB) 0300472.8

(51) Int. Cl. H04N 5/00

(52) U.S. Cl. 386/126

(57) ABSTRACT

The invention provides an Optical Mechanical Assembly (OMA) for use in a portable optical data storage device, having a single piece chassis with mounting means for mounting components of the portable optical storage device. The chassis mounting means can mount the windings of the disc spindle motor, the control circuit of the disc spindle motor and the motor shaft of the disc spindle motor. The invention provides improvements to the drive design, which can reduce cost, improve tolerancing and build time.

The present invention relates to recordable/re-writable optical storage technology, especially portable CD and DVD drives. In particular, the invention relates to mechanical improvements to the drive design, which can reduce cost, improve tolerancing and build time.

The basis for nearly all optical data storage systems to date has been the Compact Disc format proposed by Philips and Sony, some 20 years ago. This standard has been modified from the original audio storage, to include data of all formats, and also Recordable/re-writable versions. The CD has become a familiar standard, and the flexibility has lead to an increasing variety of uses. The creation of DVD over the last few years has expanded the capacity of optical data storage available to the consumer, whilst maintaining a familiar look and feel. In particular, growth has been seen in portable solutions, and these portable solutions have specific requirements separate from the needs of a PC based solution. The needs of a portable solution include small size, and improved power consumption. Additionally portable optical data storage solutions can often be directed more towards the consumer electronic environment, which has very tight cost restrictions.

An optical data storage device consists of a number of sections which can be divided into mechanical, electronic and firmware. Historically Optical Mechanical Assemblies (OMA) for use in CD, CDRW, DVD and recordable DVD drives require a chassis which has location features to mount the guide rail and the leadscrew (for location of the Optical Pick Up (OPU) reading/recording head), the sled motor which traverses the OPU across the data area of the disc and the spindle motor for spinning the disc. The spindle motor typically is purchased from a specialised motor supplier who would supply the motor with a mounting plate for attachment to the chassis via screws. Typically in portable optical data storage systems, a scaled down version of the OMA used in non-portable applications, such as PC CD drives etc, is created. Designs are known that have enabled the integration of the OMA unit within the drive body thus reducing some component count and tolerancing. However, the integrated OMA still required a separate motor assembly and sled drive system, and was suitable for a complete product design only, rather than an “engine” solution for use in a wide variety of products.

It is an object of the present invention to provide an improved chassis for the Optical Mechanical Assembly for an optical data storage device.

According to a first aspect of the present invention there is provided an Optical Mechanical Assembly (OMA) for use in a portable optical data storage device, comprising a single piece chassis having mounting means for mounting components of the portable optical storage device thereon.

Preferably said mounting means is a mounting plate for the motor shaft of the disc spindle motor.

Preferably said mounting means is a mounting plate for the windings of the disc spindle motor.

Preferably said mounting means is a mounting plate for the control circuit of the disc spindle motor.

Preferably the chassis is made from metal.

Preferably said mounting means is the mounting plate for the sled motor.

Preferably said mounting means is the mounting plate for the drive system.

Preferably said mounting means is the mounting plate for the leadscrew.

Preferably said mounting means is the mounting plate for a first guide rail.

Preferably, a sled motor is attached to said mounting plate, the sled motor being driven onto the leadscrew via a gearbox assembly.

Alternatively, a sled motor is attached to said mounting plate, the sled motor being driven directly from a stepper motor onto the leadscrew.

Preferably a second guide rail is mounted on the chassis and the sled motor driven from the leadscrew acts on the OPU via this second guide rail via a cam. This reduces vibrational susceptibility.

Preferably screws are used to allow for OPU tilt adjustment. Preferably the screws are mounted on both ends of the first guide rail, and one end of the leadscrew.

Preferably there are three screws.

Optionally the screws are mounted on both ends of the leadscrew and one end of the first guide rail.

Preferably the screws are mounted on both ends of one of the first or second guide rails, and one end of the other to allow for OPU tilt adjustment.

Preferably the screws are spring mounted.

In order to provide a better understanding of the present invention, an embodiment will now be described by way of example only and with reference to the accompanying Figures, in which:

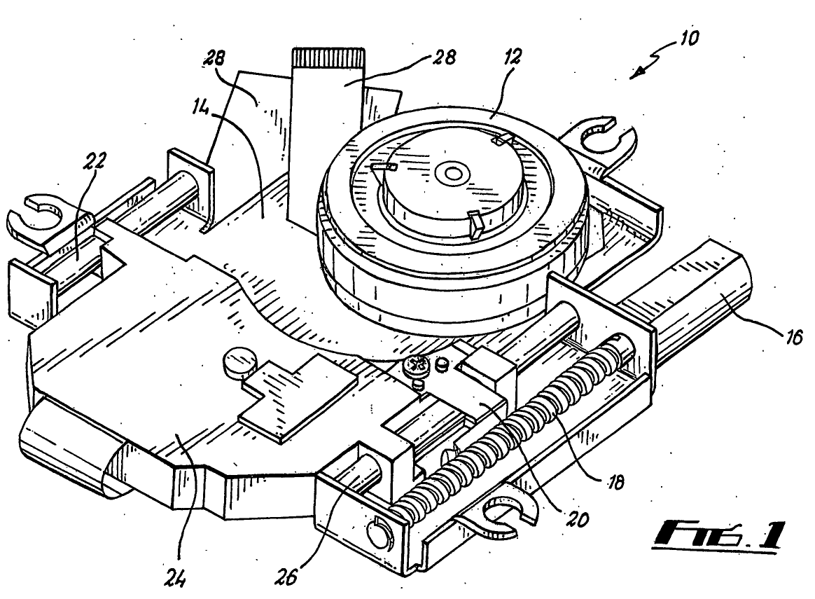

FIG. 1 illustrates, in schematic form an optical mechanical assembly, in accordance with a preferred embodiment of the present invention; and

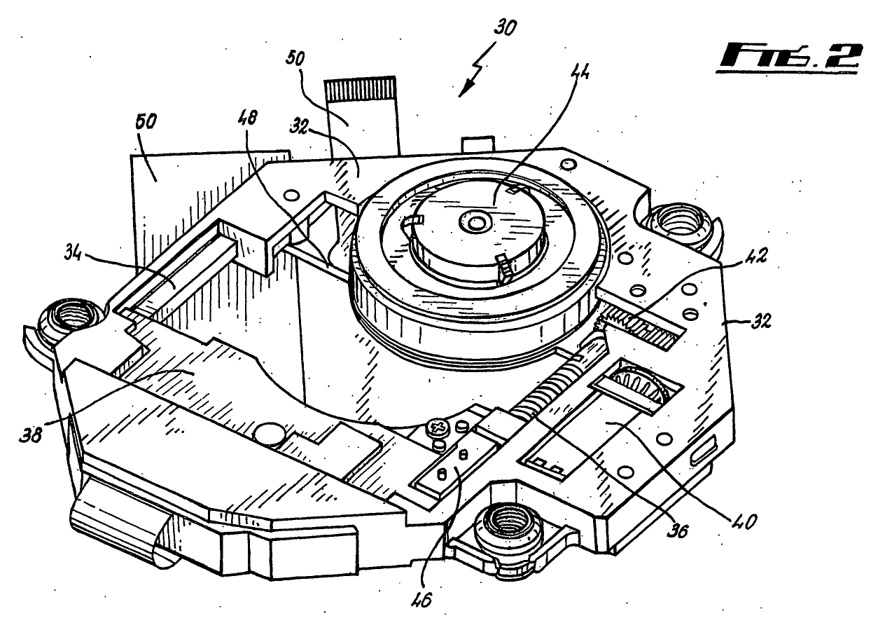

FIG. 2 illustrates, in schematic form a conventional optical mechanical assembly.

The present invention is an OMA chassis that is manufactured from a single piece of material. This chassis replaces the spindle motor base plate, and preferably the mounting for the sled motor, and may contain locators for the leadscrew and guide rail.

With reference to FIG. 1, the OMA 10 incorporates the metal mounting plate 14 of the motor 12 into the metal chassis plate 14 of the OMA. The metal part of the chassis is thus manufactured with an additional area where the motor is sited. The chassis plate then has the motor shaft, windings and control circuit mounted to it directly thus combining the motor plate and the chassis. Rigid materials other than metal may be used.

The chassis also acts as the mounting plate for the sled motor 16 and drive system and as the mounting for the leadscrew 18 that moves the drive cam 20.

The chassis also acts as the mounting plate for the guide rail 22 required for the Optical PickUp (OPU) 24.

The OPU sled motor motion may be driven onto the leadscrew via a gearbox assembly.

The sled motor motion may be driven directly from a stepper motor onto the leadscrew.

An additional guide rail 26 is mounted and the sled drive from the lead screw acts on the OPU via this additional guide rail using the cam, thus reducing vibrational susceptibility.

Three spring mounted screws are used to allow for OPU tilt adjustment. The three screws may be mounted on either end of the guide rail, and one end of the leadscrew. Alternatively the three screws may be mounted either end of the leadscrew and one end of the guide rail. The three spring mounted screws are used to allow for OPU tilt adjustment. The three screws may be mounted on either end of one of the guide rails, and one end of the other.

Flex connectors 28 are also shown.

With reference to FIG. 2, that shows a conventional OMA 30 for use in CD, CDRW, DVD and recordable DVD drives, the OMA incorporates a chassis 32 which has location features to mount the guide rail 34, the leadscrew 36 for location of the Optical Pick Up (OPU) 38 reading/recording head, the sled motor 40 and gear train 42 which traverses the OPU across the data area of the disc and the spindle motor 44 for spinning the disc. The leadscrew provides drive to the OPU, and the motion is transferred via the use of a cam 46. The spindle motor comprises a mounting plate 48 for attachment to the chassis using screws. Flex connectors 50 are also shown.

The advantages of the present invention are a reduction in the overall size of the OMA, as well as a subsequent reduction in the part count and hence overall cost. The present invention also has the effect of improving the tolerancing of the OMA and in particular the location of the lead screw and guide rail (or both guide rails, if two are used), which has the effect of improving tilt performance. The improved tilt performance is critical to the success of optical engine solutions, and in particular recording solutions. Improvement in tilt will result in reduced manufacturing time for the OMA and also reduce the risk in the design stage. A further advantage of using the present invention is the increase in stability and rigidity of the OMA due to the single piece construction and cross support between the guide rail and leadscrew. The increase in rigidity and stability will improve the OMA performance, particularly at high speed operation.

Further modifications and improvements may be added without departing from the scope of the invention herein described.

1. An Optical Mechanical Assembly for use in a portable optical data storage device, comprising a single piece chassis.

2. An Optical Mechanical Assembly as claimed in claim 1, further comprising mounting means for mounting components of the portable optical storage device thereon.

3. An Optical Mechanical Assembly as claimed in claim 2, wherein, said mounting means is a mounting plate for a motor shaft of a disc spindle motor.

4. An Optical Mechanical Assembly as claimed in claim 2, wherein, said mounting means is a mounting plate for a windings of a disc spindle motor.

5. An Optical Mechanical Assembly as claimed in claims 2, wherein said mounting means is a mounting plate for a control circuit of a disc spindle motor.

6. An Optical Mechanical Assembly as claimed in claim 1, wherein the chassis is made from metal.

7. An Optical Mechanical Assembly as claimed in claim 2, wherein said mounting means is a mounting plate for a sled motor.

8. An Optical Mechanical Assembly as claimed in claim 2, wherein, said mounting means is a mounting plate for a drive system.

9. An Optical Mechanical Assembly as claimed in claim 2, wherein said mounting means is a mounting plate for a leadscrew.

10. An Optical Mechanical Assembly as claimed in claim 2, wherein said mounting means is a mounting plate for a first guide rail.

11. An Optical Mechanical Assembly as claimed in claim 2, wherein said mounting means is a mounting plate, wherein a sled motor is attached to said mounting plate, the sled motor being driven onto a leadscrew via a gearbox assembly.

12. An Optical Mechanical Assembly as claimed in claim 2, wherein said mounting means is a mounting plate, wherein a sled motor is attached to said mounting plate, the sled motor being driven directly from a stepper motor onto a leadscrew.

13. An Optical Mechanical Assembly as claimed in claim 12, wherein a second guide rail is mounted on the chassis, such that the sled motor that drives the leadscrew acts on an optical pickup via the second guide rail via a cam to reduces vibrational susceptibility.

14. An Optical Mechanical Assembly as claimed in claim 13, wherein a plurality of screws are used to allow for OPU tilt adjustment of the optical pickup.

15. An Optical Mechanical Assembly as claimed in claim 14, wherein the screws are mounted on both ends of a first guide rail, and one end of the leadscrew.

16. An Optical Mechanical Assembly as claimed in claim 14, wherein the plurality of screws comprises three screws.

17. An Optical Mechanical Assembly as claimed in claim 14, wherein the screws are mounted on both ends of the leadscrew and one end of a first guide rail.

18. An Optical Mechanical Assembly as claimed in claim 14, wherein the screws are mounted on both ends of at least one of a first guide rail and the second guide rail, and one end of at least one of the first guide rail and the second guide rail to allow for optical pickup tilt adjustment.

19. An Optical Mechanical Assembly as claimed in claim 14, wherein the screws are spring mounted.
